(19) United States
(12) Patent Application Publication
(10) Pub. No.: US 2021/0368232 A1
(43) Pub. Date: Nov. 25, 2021

(54) METHOD FOR THE PLAYBACK OF AN ENCRYPTED MULTIMEDIA STREAM WITH QUICK ACCESS TO THE FREE-TO-AIR CONTENT AND DEVICE FOR THE USE THEREOF

(71) Applicant: SAGEMCOM BROADBAND SAS, RUEIL MALMAISON (FR)

(72) Inventor: Sébastien SIMONIN, RUEIL MALMAISON (FR)

(21) Appl. No.: 16/635,823

(22) PCT Filed: Jul. 18, 2018
(86) PCT No.: PCT/EP2018/069525

§ 371 Date: Jan. 31, 2020

(30) Foreign Application Priority Data
Aug. 2, 2017 (FR) 1757428

(51) Int. Cl. H04N 21/4405; H04N 21/438; H04N 21/433; H04N 21/2343

(52) U.S. Cl. CPC H04N 21/4405; H04N 21/2343; H04N 21/4331; H04N 21/4384

(57) ABSTRACT

A method for the playback of an encrypted multimedia stream, by a receiving terminal, with fast access to the content in the clear, wherein the multimedia stream is broadcast according to an adaptive broadcasting protocol, the multimedia stream is described by a manifest including several sections, each section corresponding to different physical features, the playback of the stream being initialised by simultaneously implementing the following procedures: downloading segments corresponding to a start-up section; initiating a process of acquiring a decryption key; downloading adapted segments according to the adaptive protocol; processing the start-up section segments to obtain the decryption key, obtaining the decryption key: terminating the processing of the start-up section segments, processing the adapted segments.

### TECHNICAL FIELD OF THE INVENTION

The object of the invention is a method for the playback, by a receiver terminal, of an encrypted media stream with fast access to the free-to-air content.

The field of the invention is that of streaming media streams and encrypted media streams.

More precisely, the field of the invention is that of the use of adaptive streaming protocols for streaming media streams and encrypted media streams.

### STATE OF PRIOR ART

Adaptive streaming protocols (HLS, Smooth Streaming, DASH . . . ) enable the quality of an audio/video stream to be adjusted as a function of network pass-band variations in order to provide the best possible user experience. The purpose of implementing of such a protocol is to obtain a display with the best possible quality without interruption. Such that display is that which corresponds to physical characteristics such as the pass-band used is maximum and in the order of 3 000 kilobits per second. With the advancement of displays (4K screens), these pass-bands run the risk of having to be increasingly large in spite of the evolution of compression algorithms.

These adaptive protocols are based on encoding the content into multiple quality representations and thus with a variable rate. These adaptive protocols cut off these representations into short duration segments. A segment is comparable to a short duration media file. A representation can contain only audio, only video or audio-video data. The representations and segments are then referenced in a manifest. Playback software for such streams have a download access to the manifest and to the segments described in the manifest.

For a given media program, a manifest includes several sections, each section corresponding to a given quality. Each section references segments such as those previously described. A section also includes different data enabling the section characteristics to be described. Each section corresponds to a representation.

Several adaptive streaming protocols are known such as:
HLS for HTTP Live Streaming;
Smooth Streaming, or else
DASH.

The startup sequence, once the media program is selected by a user, consists in downloading the manifest, and then audio/video segments, by choosing the most adapted representation. When the audio/video buffers are sufficiently filled, the playback software processes the content of the segments to:
extract the content therefrom,
decode the extracted content, and then
display the decoded content to the user.

In practice, data to be displayed are encapsulated in a TS or MPEG-4 container.

Generally, the playback software begins with downloading segments from the representation with the lowest bit rate, and gradually increases the quality of downloaded segments, as a function of the available pass-band over the network. The diagram of FIG. 1 shows an example of downloaded and displayed segments at startup as a function of time.

FIG. 1 shows a date t0 at which a user of playback software activates a media program, that is he/she chooses a program from a menu. This causes the manifest corresponding to the activated program to be downloaded. Once the manifest is downloaded, at a date t1 subsequent to t0, the playback software performs the following actions:
downloading segments referenced by the manifest;
starting acquiring of the decryption key. Procedures for obtaining the decryption key are described in the manifest.

FIG. 1 shows that:
the first segment is downloaded with a first quality corresponding to a first bit rate;
the second segment is downloaded, after the first segment, with a second quality corresponding to a second bit rate higher than the first bit rate;
the third segment and the fourth segment are downloaded, after the second segment, with a third quality corresponding to a third bit rate higher than the second bit rate;
the fifth segment and the sixth segment are downloaded, after the fourth segment, with a fourth quality corresponding to a fourth bit rate higher than the third bit rate;
the next segments are downloaded with a fifth quality corresponding to a fifth bit rate higher than the fourth bit rate.

In practice, increase in the bit rate stops when the downloading time of a segment becomes closer to the duration of a segment. If the downloading time becomes higher than this duration, then the bit rate decreases.

FIG. 1 shows a date t2, subsequent to t1 by several seconds, at which the playback software receives the decryption key and begins displaying the content of the downloaded segments by beginning with the first segment.

In other words, a user has to wait for several seconds between the instant at which he/she selects a program and the instant at which he/she actually views it.

### DISCLOSURE OF THE INVENTION

The invention provided enables the startup time for viewing an encrypted media program, delivered as a media stream, by a user, to be reduced, by allowing viewing a content until the key acquisition is ended.

One object of the invention is thus a method for the playback, by a receiver terminal, of an encrypted media stream with fast access to free-to-air content characterised in that, the media stream is streamed according to an adaptive streaming protocol, the media stream is described by a manifest including several sections, each section corresponding to different physical characteristics, initialising the stream playback is made by implementing, in parallel, the following steps of:
downloading segments corresponding to a startup section;
starting up a process of acquiring a decryption key;
downloading adapted segments according to the adaptive protocol;
processing the segments of the startup section until the decryption key is obtained, upon obtaining the decryption key:
   stopping processing the segments of the startup section,
   processing the adapted segments.

Besides the main characteristics just mentioned in the previous paragraph, the method according to the invention can show one or more complementary characteristics from the following ones, considered individually or according to any technically possible combinations:
the segments of the startup section are of a lower quality than the adapted segments.
the physical characteristics of the startup section are such that the corresponding segments are compatible for streaming with a pass-band lower than or equal to 256 kilobits per second;
the physical characteristics of the startup section are such that the corresponding segments are compatible for streaming with a pass-band lower than or equal to 1 000 kilobits per second;
a startup section includes, in its description, a specific marker;
downloading the adapted segments begins at a position subsequent to that of the already downloaded startup segments;

Another object of the invention is a method for the adaptive streaming of a media stream by a streaming server to a receiver terminal implementing a playback method characterised in that, upon receiving a request, the server implements the following steps of:
analysing the nature of the requested segment;
if the requested segment is of the startup nature:
   searching for a previous request for the requester
      if a previous request is found, calculating the age of the received request relative to the previous request, if this age is higher than a first predetermined threshold, then no answer is emitted
      if no request is found, creating a tracking record including an identifier of the requester and the date of receipt of the received request, and then continuing processing the request.

The streaming method, in one alternative, can also be characterised in that a tracking record is erased if its age is higher than a second predetermined threshold.

Another object of the invention is a non-transitory memory device including instruction codes for implementing the method according to one of the possible combinations of one of the abovementioned characteristics.

Another object of the invention is a receiver terminal for a media stream using an adaptive streaming protocol according to one of possible combinations of the abovementioned characteristics.

Another object of the invention is a computer program product comprising instructions which, when the program is executed by a computer, cause the same to implement the steps of the method for the playback of a media stream according to one of the above stated alternatives.

### BRIEF DESCRIPTION OF THE FIGURES

Further characteristics and advantages of the invention will appear upon reading the description that follows, with reference to the appended figures, which illustrate:

FIG. 1: an illustration of a time sequence for the playback of a media program streamed according to an adaptive protocol;

FIG. 2: an illustration of a time sequence for the playback of a media program streamed according to an adaptive protocol and according to the invention;

FIG. 3: an illustration of a receiver terminal for implementing the method according to the invention;

FIG. 4: an illustration of steps of the method according to the invention;

FIG. 5: an illustration of an alternative of a time sequence for the playback of a media program streamed according to an adaptive protocol and according to the invention.

For the sake of clarity, identical or similar elements are marked with identical reference marks throughout the figures.

The invention will be better understood upon reading the description that follows and upon examining the accompanying figures. These are shown by way of indicating and in no way limiting purposes for the invention.

### DETAILED DESCRIPTION OF ONE EMBODIMENT

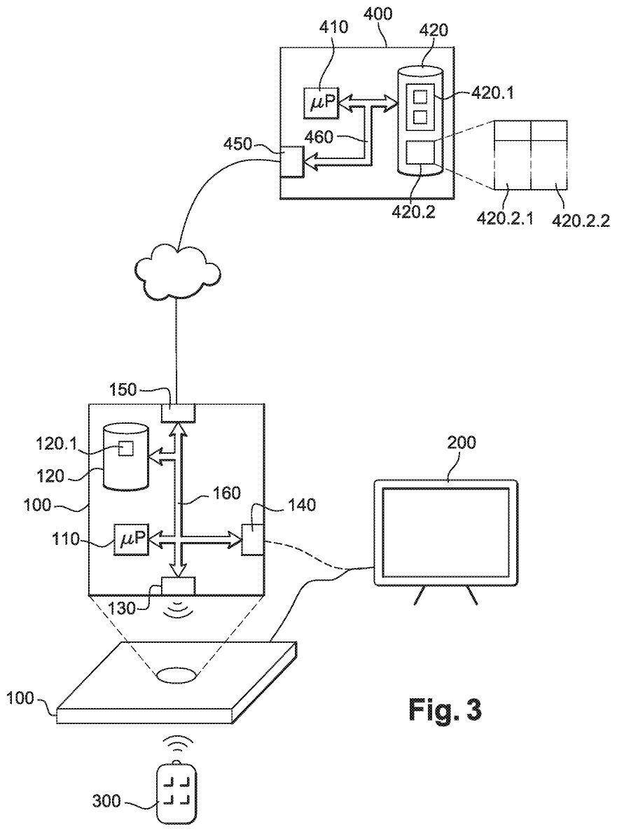

FIG. 3 shows an audio/video reception equipment 100. FIG. 3 shows that the equipment 100 is connected to a screen 200 and remote controllable by a remote controller 300.

FIG. 3 shows that the audio/video reception equipment 100 includes:
a microprocessor 110;
storage means 120. Storage means are, for example, a hard disk, an SSD disk, a memory card, a memory component . . . ;
an interface 130 for communicating with the remote controller 300, for example an infrared communication interface or a radio communication interface;
an interface 140 for communicating with the screen 200, for example peritel, hdmi, miracast, dvi, vga communication interface, . . . ;
an interface 150 for receiving a media stream. Such an interface can be an interface to the Internet network, an interface to a television broadcast terrestrial digital network, or an interface to a satellite broadcast network. This interface list is not exhaustive. It is noted that if this interface is of the pure streaming type, also called pure downlink type, then the audio/video reception equipment also includes a communication interface allowing the transmission of messages, that is an uplink communication interface.

FIG. 3 shows that the storage means 120 of the audio/video reception equipment include at least one zone 120.1 of instruction codes including instruction codes of the invention.

FIG. 3 shows that the microprocessor 110 of the audio/video reception equipment 100, the storage means 120 of the audio/video reception equipment 100, the communication interface 130 with the remote controller of the audio/video reception equipment 100, the communication interface 140 with the screen of the audio/video reception equipment 100 and the reception interface 150 of the audio/video reception equipment 100 are interconnected through a bus 160.

In the present description, it is considered that the audio/video reception equipment 100 is a set top box. In practice, it can be a computer or a telephone/tablet. In the latter case, the telephone uses its own screen or moves its screen on another screen. The audio/video reception equipment 100 is thus also designated as a receiver terminal.

In this description, when an action is taken by a device, this action is actually performed by a microprocessor of said device controlled by instruction codes recorded in a memory of said device. In the same way, if an action is taken by a program, or an application, this action is the result of the implementation of instruction codes by a microprocessor of a device in which the program or application is installed.

FIG. 3 shows a streaming server 400. FIG. 3 shows that the server 400 includes:
a microprocessor 410;
storage means 420;
a communication interface 450 for receiving downloading requests and transmit the answers to these requests.

FIG. 3 shows that the microprocessor 410 of the streaming server 400, the storage means 420 of the streaming server 400 and the communication interface 450 of the streaming server 400 are interconnected through a bus 460.

FIG. 3 shows that the storage means 420 include several zones:
a zone 420.1 of sections enabling a plurality of sections such as those described in this document to be recorded, that is representations of an audio/video content, each section including at least one piece of information enabling the section to be identified as being a startup section or not. The absence of this piece of information indicates that the section is not a startup section.
A zone 420.2 of request tracking for recording request tracking records, a request tracking record enabling a request transmitter identifier 420.2.1 and a request reception date 420.2.2 to be associated with each other.

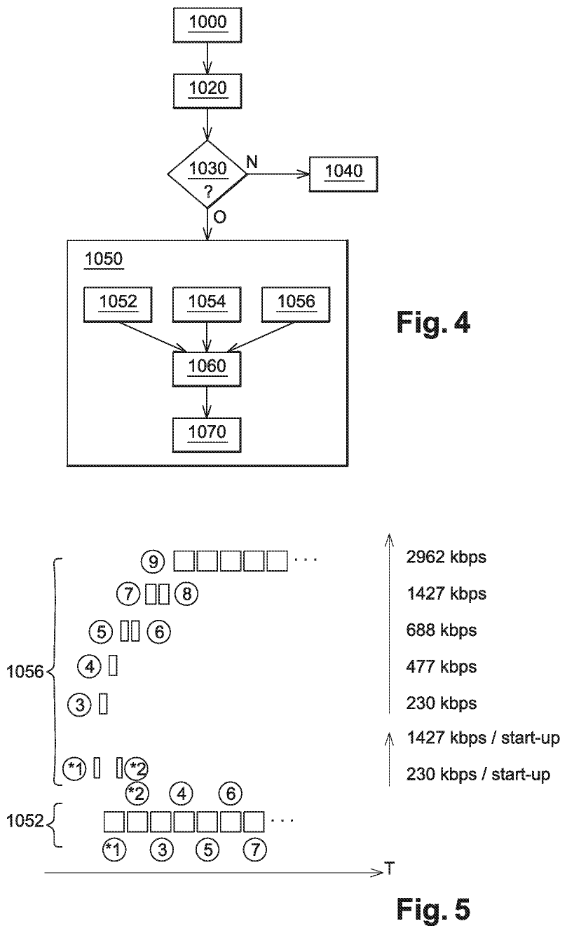

FIG. 4 shows a preliminary step 1000 in which a user of the audio/video reception equipment 100 uses the remote controller 300 to select a media program. This occurs at a first date t0 illustrated by FIG. 2. The audio/video reception equipment 100 then proceeds to a step 1020 in which it recovers the manifest file corresponding to the selected media program. In a step 1030, the audio/video reception equipment analyses the recovered manifest file to determine whether the audio/video content described by the manifest file requires a decryption key or not.

If the content does not require a decryption key, the audio/video reception equipment proceeds to a step 1040 which corresponds to processing the manifest according to the state of the art. If the content requires a decryption key, the audio/video reception equipment proceeds to a step 1050 of processing an encrypted content which corresponds to processing the manifest according to the invention.

In step 1050 of processing an encrypted content, the audio/video reception equipment initiates, at date t1, three processes in parallel:
a first process 1052 of downloading segments corresponding to a startup section of the manifest file;
a second process 1054 of acquiring a decryption key;
a third process 1056 of downloading the adapted segments, also called main segments, the content of which is encrypted.

The second process and third process are conventional processes corresponding to processing a manifest according to the state of the art.

The first process is made by searching, in the manifest, for sections being identified as being sections describing startup segments. This is possible if the manifest file is compatible with the processing described by the invention.

For example, in the case of the adaptive protocol DASH, the possibility of using the flag called “EssentialProperty” is used to customise sections called “AdaptationSet” in DASH. Therefore, there will be a section beginning as follows to designate a startup section:

<AdaptationSet id=“2”
maxWidth=“1920”
maxHeight=“1080”>
<EssentialProperty schemeIdUri=“urn.sagemcom.dash.startup”

value=“1”>

...

In this example, the important element is the value assigned to attribute xml called “schemeldUri”. Having in a manifest file DASH, a section including a field flagged by “EssentialProperty” and having this value for attribute “schemeIdUr” designates this section as being a startup section.

In another example, in the case of the adaptive protocol Smooth Streaming, the possibility of using the flag called “CustomAttributes” is used. In the case of Smooth Streaming, therefore there will be, in the customisable fields, a field the name of which is “kind” and the value of which is predefined, for example “startup”. This is illustrated below.

<CustomAttributes>
<Attribute Name=“kind” Value=“startup”/>
</CustomAttributes>

Therefore it can be seen that it is possible to identify the startup sections, and thus the segments, in the manifest file.

In the invention, a startup section is such that it describes a content that can be accessed without knowing the decryption key the acquisition of which has started up with the initiating the second process.

Once all the three processes are initiated, the audio/video reception equipment proceeds to a synchronisation step 1060. The synchronisation time point is the acquisition of the decryption key. As long as the decryption key is not acquired, the audio/video reception equipment downloads the startup segments and processes them to display them on the screen.

As soon as the decryption key is acquired, the audio/video reception equipment proceeds to a step 1070 of processing the main segments in which it switches from processing startup segments to processing main segments the content of which it can now decrypt. The switching is made at the end of displaying the startup segment during which the decryption key has been acquired.

Processing a segment includes de-encapsulation, decryption, decoding, buffering and then displaying steps. The decryption step of course depends on the content nature depending on whether it is encrypted or not. Likewise, buffering can be made at any instant in the list of steps mentioned. Thus, non-decrypted segments or non-decoded segments can be buffered. It is understood that all the steps will have to have been made for each segment before displaying.

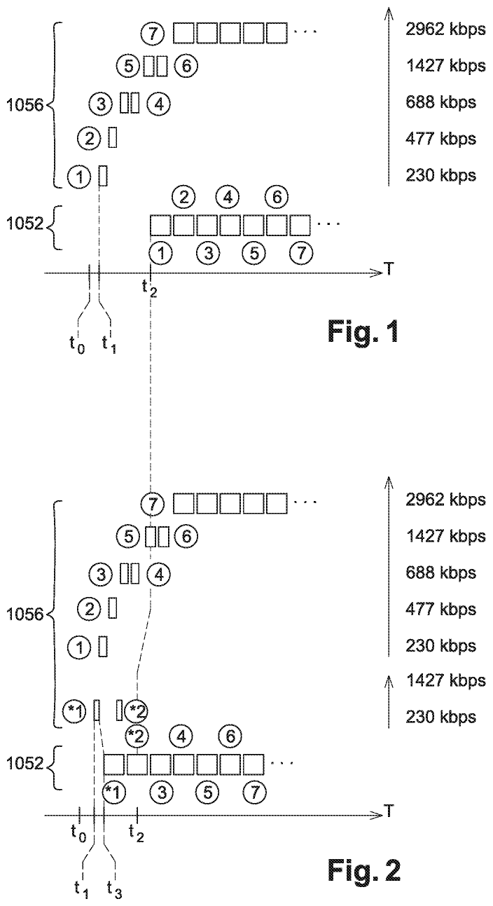

FIG. 2 illustrates an implementation of the method according to the invention. In particular, FIG. 2 shows a date t3, subsequent to date t1, at which the audio/video reception equipment has received the first startup segment. From this date on, the audio/video reception equipment begins displaying the content of this segment. It is noticed that this date is much lower than date t2, of receiving the decryption key, illustrated by FIG. 1.

FIG. 2 shows that the audio/video equipment downloads the second startup segment before the date equal to t3+duration of the first segment. This enables it, at the end of displaying the first startup segment, to be able to begin displaying the second startup segment.

FIG. 2 shows that the date t2 of receiving the decryption key is located during displaying the second startup segment. The third segment displayed will thus be the third adapted segment the content of which can be decrypted with the acquired decryption key. Displaying the program then continues from the adapted segments.

If a download or other error happens on a startup segment, the audio/video reception equipment stops current processings on startup segments and does not use the startup segments. In this case, it displays a predetermined still or moving picture to indicate to the user that the adapted segments will be soon displayed, as soon as the decryption key has been acquired.

In the invention, the startup segments have the following characteristics:
Independent of the decryption key
The startup segments are either in free-to-air content, either encrypted by a key independent of the key used by the main DRM. For example, an AES or “Clear-Key”encryption is used as an alternative encryption. The alternative key is recorded in the audio/video equipment which guarantees a fast access.
Corrupted content, in one alternative
In order to allow non-DRM streaming, filters can be applied, by a server, onto the content to degrade viewing and/or listening quality. For example, a logo overprint is used, the video is pixelated or blurred; the audio is turned OFF. The content appears degraded to the user, but is sufficient to give him/her a feedback on what is being streamed.
Reduced bit rate
In order to allow fast downloading of startup segments, the bit rate of startup segments can be reduced, for example by increasing the compression rate, by decreasing the number of video frames; by reducing the video/audio sampling frequency. The bit rate of startup segments can for example be limited to 256 kilobits per second or less. In another example, the bit rate is limited to 1 000 kilobits per second or less.
Priority downloading on the server
In order to allow fast downloading of the segments, the server which delivers the content can answer as a priority to requests on startup segments.
Limited downloading on the server
To avoid an excessive use of downloading startup segments, a server 400 can limit the number of downloading startup segments per time interval and per client. Seen from the audio/video reception equipment, this corresponds to a downloading error.

In this alternative, the server 400 performs, for each request, the following actions:
analysing the nature of the segment requested;
if the segment requested is of the startup nature then:
   searching for a previous request for the requester. This search is performed in the request tracking zone 420.2;
      if a previous request is found, calculating the age of the request received relative to the previous request, if this age is higher than a first predetermined threshold, then no answer is transmitted
      if no request is found, creating a tracking record including an identifier of the requester and the date of receipt of the received request, and then continuing processing the request.

The first threshold is, for example, 30 seconds. This first threshold can also be expressed as a multiple of the duration of a segment, for example 10 segments.

In the invention, there are two segment natures: adapted and startup. The nature of a segment is determined by the fact that the segment is part of a startup section or not. On the server side, this piece of information can be realised in several ways:
there is a table associating a segment identifier with a nature: if the segment identifier is in this table, then the segment is a startup segment, otherwise it is an adapted segment;
the segments are stored in an envelope containing a datum on the segment nature;
the segments are encapsulated in a section the envelop of which contains a datum on the segment nature;
. . .

In one alternative, the streaming server erases from the request tracking zone, all the requests the age of which is higher than a second threshold. This second threshold is, for example 10 minutes or a multiple of the duration of a segment for example 50 segments. With the example of the description, a requester thus could only obtain 10 sections every 50 sections. This erasure enables downloading startup segments to be again possible. The erasure can be actual or logic.

In one alternative, a request tracking record also enables a datum identifying a section to be associated with the transmitter identifier. This enables a requester to obtain startup segments for several sections. This alternative allows fast “zapping”.

It is noted that, in the alternative described, the request tracking zone only includes records for requests relating to startup segments. In practice, a server such as the streaming server 400 keeps a history file for requests received by the server. In one alternative, the streaming server uses this history file to perform the search for a previous request. In this case, the nature of the segment subject of the request should further be filtered to find the previous request.

In one alternative, the criterion considered is not purely the age, but a number of requests received during a predetermined period of time. In other words, the number of requests for a startup segment having less than a predetermined age is considered.

In yet another alternative, a counter per section is considered: a requester is not permitted to request more than a predetermined number of startup segments per section.

The purpose of this behaviour is to not enable actual viewing of an audio/video content by making use of startup sections.

In one alternative of the invention, for the third process of downloading the adapted segments, it directly begins at a segment the rank of which is subsequent to the ranks of already downloaded startup segments. Indeed, if it is downloaded, the first adapted segment, will probably never be used because the first startup segment will have been already displayed. FIG. 5 illustrates that the audio/video reception equipment starts downloading the adapted segments from the third segment.

1. A method for a playback, by a receiver terminal, of an encrypted media stream with fast access to free-to-air content wherein, the media stream is streamed according to an adaptive streaming protocol, the media stream is described by a manifest including several sections, each section corresponding to different physical characteristics, the method comprising initialising the stream playback by implementing, in parallel, the following steps of:
downloading segments corresponding to a startup section;
starting up a process of acquiring a decryption key;
downloading adapted segments according to the adaptive streaming protocol;
processing the segments of the startup section until the decryption key is obtained, upon obtaining the decryption key:
stopping processing the segments of the startup section,
the adapted segments.

2. The method for the playback of an encrypted media stream according to claim 1, wherein the physical characteristics of the startup section are such that the corresponding segments are compatible for streaming with a pass-band lower than or equal to 256 kilobits per second.

3. The method for the playback of an encrypted media stream according to claim 1, wherein the physical characteristics of the startup section are such that the corresponding segments are compatible for streaming with a pass-band lower than or equal to 1 000 kilobits per second.

4. The method for the playback of an encrypted media stream according to claim 1, wherein a startup section includes, in its description, a specific marker.

5. The method for the playback of an encrypted media stream according to claim 1, wherein downloading the adapted segments begins at a position subsequent to that of the already downloaded startup segments.

6. A method for the adaptive streaming of a media stream by a streaming server to a receiver terminal implementing a playback method according to one of the preceding claims, wherein, upon receiving a request, the server implements the following steps of:
analysing the nature of the requested segment;
when the requested segment is of the startup nature, then:
searching for a previous request for the requester
if a previous request is found, calculating an age of the received request relative to the previous request, if the age is higher than a first predetermined threshold, then no answer is emitted,
if no request is found, creating a tracking record including an identifier of the requester and the date of receipt of the received request, and then continuing processing the request.

7. The streaming method according to claim 6, wherein a tracking record is erased if its age is higher than a second predetermined threshold.

8. A non-transitory memory device including instruction codes for implementing the method according to claim 1.

9. A receiver terminal of a media stream using an adaptive streaming protocol according to claim 1.

10. A computer program product including instructions which, when the program is executed by a computer, cause the same to implement the steps of the method according to claim 1.
